(19) United States
(12) Patent Application Publication
(10) Pub. No.: US 2010/0320155 A1
(43) Pub. Date: Dec. 23, 2010

(54) Methods For Removing Dissolved Metallic Ions From Aqueous Solutions

(75) Inventors: Michael L. Enos, Colorado Springs, CO (US); W. Lowell Morgan, Monument, CO (US); Randal R. Gingrich, Colorado Springs, CO (US)

Correspondence Address: Don D. Cha, 547 Buena Vista Road, Golden, CO, 80401, US

(73) Assignee: AUXSOL, INC., Colorado Springs, CO (US)

(21) Appl. No.: 12/866,893

(22) PCT Filed: Feb. 11, 2009
(86) PCT No.: PCT/US09/33838

§ 371 Date: Aug. 10, 2010

Related U.S. Application Data
(62) Division of application No. 61/027,811, filed on Feb. 11, 2008.

(51) Int. Cl. C02F 1/52; C02F 1/66; C02F 1/34; C02F 1/461

(52) U.S. Cl. 210/717; 210/702

(57) ABSTRACT

The invention provides methods for treating aqueous solutions to remove dissolved metallic ions.

### CROSS-REFERENCE TO RELATED APPLICATIONS

This application claims the priority benefit of U.S. Provisional Application No. 61/027,811, filed Feb. 11, 2008, which is incorporated herein by reference in its entirety.

### FIELD OF THE INVENTION

The present invention relates to methods and devices for reducing the amount of dissolved metallic ions from aqueous solutions.

### BACKGROUND OF THE INVENTION

Most conventional methods for purifying water use osmosis, filtration, ion-exchange and/or ozonolysis. Each of these conventional methods has its own drawbacks. For example, osmosis is rather slow and often requires an expensive membrane and can generate large volumes of waste streams. Filtration typically removes only solids or microorganisms that are present in the aqueous solution. Ion-exchange often removes various ions but adds a relatively large concentration of sodium ion in exchange for removing other cations. Thus, ion-exchange only replaces one ion with another without reducing the amount of total ions in the aqueous solution. Ozonolysis does not remove any ions but is typically used to disinfect the water supply.

As discussed above, there are various methods available for removing various metallic ions from aqueous solutions. However, conventional methods are generally not applicable to industrial scale processes. For example, ion-exchange process works well in residential-like settings where the aqueous solution to be treated is often a relatively small amount, e.g., tens of gallons per minute at most. But in industrial processes where thousands and even millions of gallons of water is generated that need treatment, conventional ion-exchange processes are not suitable.

Industrial processes such as oil production, oil refinery, power generation, etc. produce thousands or even millions of gallons of water that need to be treated or processed before being released into the environment or recycled. Conventional methods for treating such water typically involve minimal treatment to remove mainly environmentally toxic materials, suspended solids, and in some cases hydrocarbons from the waste water stream. In fact, most-if not all-conventional processes for treating industrial waste water do not remove any significant amount of metallic ions that are typically present in such aqueous solutions. While the presence of metallic ions in aqueous solutions is not necessarily detrimental, such aqueous solution cannot be recycled for use and often has undesired environmental impact. For example, water containing relatively high concentrations of metal ions are not suitable for human or animal consumption. In addition, in many instances if such water is reused in industrial processes or oil recovery, it causes scaling in industrial equipments or in geologic formations.

Therefore, there is a need for removing various metallic ions from aqueous solution.

### SUMMARY OF THE INVENTION

Some aspects of the invention provide methods for reducing the amount of dissolved metallic ions from an aqueous solution comprising the same. Methods of the invention generally involves precipitating out the dissolved metallic ion from the aqueous solution by forming an insoluble metallic species such as, but not limited to, metallic carbonates and metallic hydroxides.

Some particular aspects of the invention comprise forming a metallic carbonate that precipitates out of the aqueous solution. In these aspects of the invention, a carbonate source is added to the aqueous solution under conditions sufficient to produce carbonate ion in situ. Metallic ions that can be reduced are those that form a relatively insoluble precipitate with carbonate ion. Suitable carbonate sources include, but are not limited to, carbon dioxide, trona, bicarbonate salts, carbonate salts, and other compounds that form carbonate ion in water.

In some embodiments, the solubility constant for the metallic ion carbonate is about 10³ or less under standard conditions.

Yet in other embodiments, the metallic ion comprises a hardness ion, sodium ion, or a mixture thereof. Within these embodiments, in some instances, the hardness ion comprises an alkali earth metal ion, a transition metal ion, lithium ion, or a combination thereof. Still in other instances, the hardness ion comprises calcium ion, magnesium ion, manganese ion, barium ion, iron ion, copper ion, strontium ion, or a combination thereof. In some particular cases, the hardness ion comprises calcium ion.

Still in other embodiments, at least about 50% of the metallic ions are removed by methods of the invention.

In other embodiments, at least about 50% of the hardness ions are removed by methods of the invention.

Yet in other embodiments, the aqueous solution comprises industrial process water, oil field produced water, frac flowback water, saline water, other brackish water, or a combination thereof.

Still yet in other embodiments, the carbonate ion is produced by dissolving carbon dioxide gas in an aqueous solution under conditions sufficient to produce carbonate ions. Within these embodiments, in some instances, the carbon dioxide gas is produced from an industrial process.

Yet still in some embodiments, methods of the invention further comprises maintaining the pH of the aqueous solution at about pH 8 or higher. Within these embodiments, in some instances the step of maintaining the pH of the aqueous solution comprises adding a compound that serves as a hydroxide ion source or producing (or generating) hydroxide ions, typically without adding a chemical compound. In some cases, the step of maintaining the pH of the aqueous solution comprises generating hydroxide ions. Hydroxide ions can be generated using any methods known to one skilled in the art. In one particular case, hydroxide ions are generated by electron beam, corona discharge, particle beam, ultrasonic cavitation, hydrodynamic cavitation, ultraviolet light, plasma, electrolysis, or a combination thereof.

Other aspects of the invention provide methods for reducing the amount of dissolved hardness ion from an aqueous solution comprising the same. In these aspects of the invention, methods typically comprise producing hydroxide ion from the aqueous solution to precipitate a hydroxide of the hardness ion, thereby reducing the amount of dissolved hardness ion from the aqueous solution. Metallic ions that are reduced by these aspects of the invention are those that form a relatively non-soluble metal hydroxide compound.

In some embodiments, the hydroxide ion is generated by a process comprising electron beam, corona discharge, particle beam, ultrasonic cavitation, hydrodynamic cavitation, ultraviolet light, plasma, electrolysis, radio or microwave radiation, or a combination thereof. Still in other embodiments, the hydroxide ion is generated by a process comprising corona discharge.

### BRIEF DESCRIPTION OF THE DRAWINGS

FIG. 1 is a graph showing the relative amount of carbon dioxide, bicarbonate ions, and carbonate ions present at various pH levels.

FIG. 2 is a graph showing quantum efficiencies of photoionization and photodissociation in liquid water as functions of photon energy.

FIGS. 3A and 3B are graphs showing the result of Barnett Shale water samples that were treated with NaHCO₃ and soda ash Na₂CO₃, respectively. The amount of calcium ion concentration decreased significantly as the amount of sodium bicarbonate and sodium carbonate addition increased.

FIG. 4 is a 3-D plot showing the relationship between pH, CO₂ pressure, and NaOH Concentration.

FIG. 5 is a 3-D graph showing the relationship between total hardness (mg/L), CO₂ and NaOH.

FIG. 6 is a 3-D graph showing the relationship between the total alkalinity, CO₂, and NaOH

### DETAILED DESCRIPTION OF THE INVENTION

Descriptions of well known processing techniques, components, and equipment are omitted so as not to unnecessarily obscure the present methods and devices in unnecessary detail. The descriptions of the present methods and devices disclosed herein are exemplary and non-limiting. Certain substitutions, modifications, additions and/or rearrangements falling within the scope of the claims, but not explicitly listed in this disclosure, will become apparent to those of ordinary skill in the art based on this disclosure.

The present invention relates to reducing the amount of dissolved metallic ions from aqueous solutions. In some aspects of the invention, dissolved metallic ions in the aqueous solution are removed by precipitation as a corresponding carbonate ion complex. Within these aspects of the invention, in some embodiments the methods and apparatuses comprise one or more of the following general processes: a carbonation process whereby carbon dioxide is dissolved into or absorbed by the aqueous solution under conditions sufficient to form carbonate ions, bicarbonate ions, or a mixture thereof; and a precipitation process whereby the metal carbonate is precipitated from the aqueous solution. Unless the context requires otherwise, “carbonate” refers to carbonate, bicarbonate, or a mixture thereof of the corresponding species.

As noted above, in certain embodiments, the apparatuses and methods of the invention employ an aqueous carbonation process, whereby a carbonate source (e.g. carbon dioxide) is dissolved into the aqueous solution to form carbonate ions. It should be noted, however, that at standard pressure and temperature conditions, the solubility of carbon dioxide is about 90 cm³ of CO₂ per 100 mL of water. In some embodiments, the carbon dioxide is pressurized to increase the amount of carbon dioxide which dissolves in the aqueous solution. However, the scope of the invention does not require pressurization of carbon dioxide. Typically, the gaseous emission stream that comprises a carbonate source is added to the aqueous solution at a pressure of at least about 1 psi of pressure, often at least about 10 psi of pressure, and more often at least about 1 atm. In some embodiments, the carbonate source is added to the aqueous solution at a pressure of from about 1 psi to about 10 psi. In other embodiments, the gaseous emission stream is pressurized to from about 10 psi to about 15 psi. Still in other embodiments, the gaseous emission stream is pressurized to from about 1 atm to about 10 atm. Carbon dioxide used can be in any one or more of the phases, e.g., gas, liquid, solid, or a combination thereof. Further, that the scope of the invention is not limited to these particular pressures as different pressurization and/or temperature can also be used to achieve desired carbonation of the aqueous solution. In other embodiments, the temperature of aqueous solution is lowered to increase carbon dioxide adsorption. Still in other embodiments, a mixture of air or other inert gas and CO₂ is used to produce carbonate ion in the aqueous solution.

In aqueous solution, carbon dioxide exists in many forms. Initially, it dissolves in water, as described by the reaction:

CO_{2(g)} [symbol] CO_{2(aq)}.

Then, an equilibrium reaction condition is established between the dissolved CO₂ and carbonic acid (H₂CO₃) as described by the reaction:

CO_{2(aq)}+H₂O₍₁₎ [symbol] H₂CO_{3(aq)}.

Without being bound by any theory, it is believed that in pure water only about 1% of the dissolved CO₂ exists as H₂CO₃. That is because carbonic acid is a weak acid which dissociates in two steps, shown below:

H₂CO₃ [symbol] H⁺+HCO₃¹Kₐ₁=4.2×10⁻⁷,

HCO₃⁻= [symbol] H⁺+CO₃⁻²Kₐ₂=4.8×10⁻¹¹.

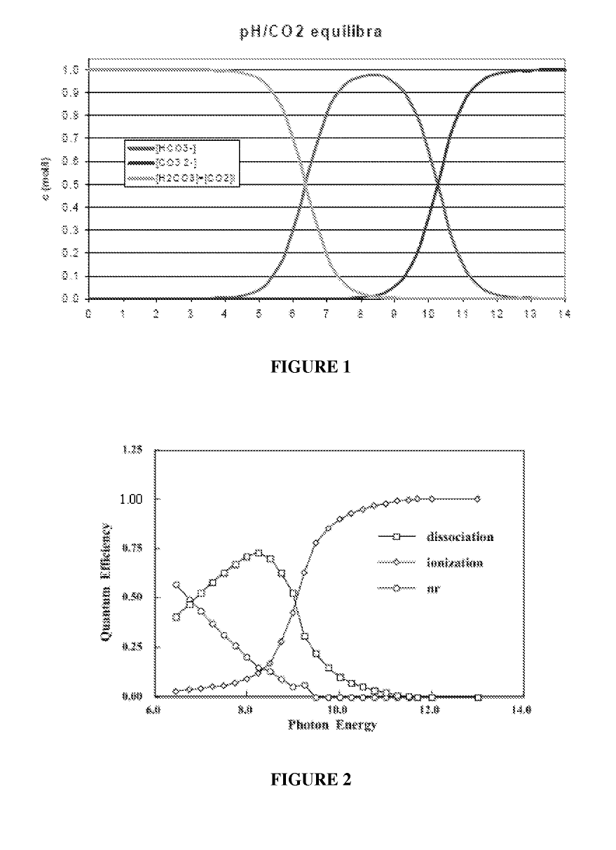

FIG. 1 shows equilibrium concentration curves for carbon dioxide, bicarbonate, and carbonate at various pH values in pure water. As shown in FIG. 1, when carbon dioxide is brought into contact with an aqueous solution, a continuum of products that range from pure dissolved carbon dioxide to bicarbonate ions (HCO₃⁻¹) to pure carbonate ions (CO₃⁻²) can be formed, depending on the pH of the solution. Accordingly, in order to form carbonate ions from the dissolved carbon dioxide, the aqueous solution needs to be at a certain pH level. In some embodiments, the aqueous solution is at least about pH 8, often at least about pH 8.2 more often at least about pH 8.5, and more often at least about pH 10.5. The equilibrium curve shown in FIG. 1 represents equilibrium at a particular condition, e.g., at a standard pressure and temperature in pure water. Thus, it should be appreciated that the pH necessary to convert dissolved carbon dioxide to carbonate ions can vary depending on the reaction conditions, such as the nature of ions present, etc. One skilled in the art can readily determine the minimum pH required for such a conversion at any give reaction condition and derive at an equilibrium curve similar to that shown in FIG. 1. Accordingly, while certain pH ranges are discussed above, it should be appreciated that the pH values of the aqueous solution are not limited to these specific ranges and examples given herein. The desired pH of the aqueous solution can vary depending on particular reaction conditions used, e.g., temperature and pressure, and presence of other ions including salts.

One of the factors for consideration when using gaseous carbon dioxide is the rate at which gaseous carbon dioxide dissolves in the aqueous solution. For economic reasons, it is desirable to dissolve carbon dioxide with the least energy possible. However, dissolving carbon dioxide in the aqueous solution is generally considered by one skilled in the art to be mass-transfer-limited. In practice, the impact of such a limitation can be reduced significantly or completely eliminated, for example, by using packed or un-packed columns with wide-area gas-liquid contact absorption in bubble-rising-through-fluid methods. Thus, in some embodiments, a large liquid-gas contact area is provided to aid mass transport. For example, one can employ bubble-column reactors (packed or unpacked and with/without horizontal fluid flow) that create large liquid-gas contact area to aid mass transport. In this configuration, the overall design benefits by the freedom to utilize stages with short stage height (e.g., 3 m or less) that yet achieve 90%+ absorption with little resistance or pressure head to overcome in pumping the fluids. Therefore, the stages are designed with wide horizontal area to achieve industrial scaling (wide shallow pools or the equivalent in vessels), potentially with horizontal movement to accommodate continuous operation. The scope of the present invention includes utilizing gas-liquid contactors of many other configurations, as long as those devices attain the desired or required gas-liquid contact.

Some embodiments of the invention use a wide-area liquid-gas transfer surface (bubble-column, packed or clear, or its equivalent in static or moving fluid vessels) to dissolve a relatively high amount of carbon dioxide in the aqueous solution by lowering the resistance necessary to bring the fluids into contact.

In other embodiments, liquid carbon dioxide or solid carbon dioxide (i.e., dry ice) is used rather than or in addition to the gaseous carbon dioxide. Still in other embodiments, carbon dioxide that is generated from industrial processes is used to remove metallic ions from aqueous solution. In this manner, potentially unlimited supply of carbon dioxide is available for water treatment. Furthermore, using carbon dioxide generated from industrial processes provides means of reducing carbon dioxide emission as well as water treatment, thereby providing simultaneous solutions to at least two potentially industrial waste problems. When gaseous carbon dioxide is used, especially that generated from industrial processes, one can concentrate the amount of carbon dioxide prior to contacting with the aqueous solution; however, such concentration of carbon dioxide is not necessary. For example, carbon dioxide can be concentrated from industrial emissions by using carbon dioxide absorber(s) or scrubber(s). In general, the efficiency of the methods of the present invention can be enhanced by reducing the amount of work required to dissolve carbon dioxide. To that end, high-efficiency absorber(s) (capable of removing 99% of the carbon dioxide from an incoming flue-gas stream or gaseous emission stream) can be used to achieve high carbon dioxide absorption, i.e., separation, rate. The separated carbon dioxide is then contacted with the aqueous solution under conditions sufficient to form carbonate ion. Such pre-concentration of carbon dioxide gas reduces the amount of energy required to dissolve carbon dioxide in the aqueous solution by providing a higher concentration of carbon dioxide. In addition, pre-concentration of carbon dioxide can increase the efficiency of dissolving carbon dioxide in the aqueous solution.

As stated above, when carbon dioxide is brought into contact with an aqueous solution, a continuum of products that range from pure dissolved carbon dioxide to bicarbonate ions to pure carbonate ions and carbonic acid can be formed depending on the pH of the solution. Thus, reaction conditions such as pH, temperature, and pressure will drive the equilibrium in either direction, even unto complete formation of carbonate ions. For example, cooler aqueous temperatures generally favor carbonate ion formation which enhances the processes described herein. The pH of the aqueous solution can be adjusted using any one of a variety of methods known to one skilled in the art. For example, a base (e.g., a hydroxide ion source such as metallic hydroxides, metallic hydrides, and/or metallic oxides) can be added to the aqueous solution or hydroxide ions can be generated in situ by non-chemical means as described in more detail below. While the scope of present invention includes all manners for adjusting the pH of the aqueous solution, in some embodiments, adjustment of pH is achieved by in situ generation of base, such as hydroxides. There are a wide variety of non-chemical means known to one skilled in the art for generating hydroxide ion from various aqueous solutions. Such methods include photolysis, hydrodynamic cavitation, electrolysis, electron beam, corona discharges, plasmas, sonication (e.g., ultrasonic cavitation), UV light, radio or microwave radiation and others. Each of these methods is well known to one skilled in the art.

For example, the electrolysis of water which contains sodium chloride produces hydroxide compounds according to the following equation:

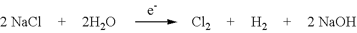

The half reaction in each electrolytic cell is:

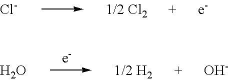

Hydrodynamic cavitation and ultrasonic cavitation generally involve the production of highly localized regions of extreme pressure. Without being bound by any theory, it is believed that both hydrodynamic and ultrasonic cavitation produce small or microscopic bubbles that collapse producing localized high temperatures and pressures internally, which produce large quantities of hydroxide radicals (OH.) by dissociation of water molecules. The use of ultrasonic cavitation produces an effect known as sonoluminescence, which involves production of high energy photons. It has been estimated that in some instances the gas temperature inside of the collapsing bubble can reach 20,000° K. The collapse of bubbles also produces blue and ultraviolet (UV) light. Hydroxyl radicals (OH.) can be formed by direct dissociation of the H₂O but also by collisions of excited oxygen and hydrogen with water molecules.

Beams of electrons, x-rays, gamma-rays, and energetic electrons generated from electrical discharges also can be used to form hydroxyl radicals (OH.), hydrogen radicals, and other highly-reactive chemical species. They ionize water molecules, producing a large number of energetic electrons per ionization event that cascade to lower energies dissociating H₂O into H radicals and hydroxide radicals as they lose energy in collisions with water molecules. Gamma-radiation and e-beams also produce solvated (aqueous) electrons in irradiated pure water. This generation of reactive species is shown by the reaction products of e⁻+H₂O shown in the braces { . . . } below:

e⁻+H₂O→{OH*+H+e⁻_{aq}}; {OH⁻+H}; {H₂O⁺+e⁻+e⁻_{aq}}; etc.

There are a number of possible combinations of product atomic and molecular species. From many past radiolysis experiments, the yields (G-values) for these species are well known, typically being about 2.7 (for OH radicals), 0.55 (for H radicals), 2.6 (for solvated electrons), and 0.71 (for H₂O₂), in units of molecules/100 eV deposited energy. In contrast, for dielectric-barrier discharges (DBDs, which are electrical-discharge streamers similar to corona discharge) in moist gases, the G-values are about 5 to 10 times smaller. For other types of electrical discharges in water (like a form of pulsed corona), generally higher production rates for hydroxide radicals and H₂O₂ in aqueous electrical discharges is observed than in radiation/e-beam techniques. It should be appreciated that different aqueous solutions provide different yield, for example, the presence of carbonate ions can scavenge active species and reduce the effective yields.

In some embodiments of the invention, hydroxyl ions or hydroxyl radicals are generated by electron beams, dielectric-barrier/corona discharges, particle beams, ultrasonic cavitation, hydrodynamic cavitation, ultraviolet light, plasmas, electrolysis, or a combination thereof.

Chlorine (i.e., Cl₂), if present, in salt water at normal pH value typically forms HClO as well as other chloride species. Ultraviolet light at wavelengths of less than about 300 nm, which can be generated readily, dissociate the HClO molecule. Without being bound by any theory, it is believed that HClO molecule dissociates into OH radical and chlorine, which can emerge from the water as Cl₂ gas. It is believed that some, but not necessarily all, of the OH radicals will combine with a solvated electron (i.e., e_{aq}) to produce hydroxide ions (i.e., OH⁻).

The photolysis (splitting) of water can be accomplished by illuminating it with ultraviolet (UV) light. This process can be described in terms of the following reactions:

hv+H₂O→H₂O* (excited-state formation)

H₂O*→H.+.OH (excited-state relaxation leading to dissociation)

2H₂O*→e_{aq}+.OH+H₃O⁺ (excited-state relaxation leading to ionization).

The quantum yields (products per light photon) for the dissociation and ionization processes in pure water are shown in FIG. 2. As FIG. 2 shows, the yield for the dissociation reaction peaks at around 8.5 eV (around a wavelength of 146 nm), while that for ionization peaks at a higher energy of around 11.7 eV (around a wavelength of 106 nm; a value thought to be the ionization potential of water). Practical UV-light sources like mercury lamps have wavelengths of 254 nm/˜4.9 eV, which according to FIG. 2 would have quantum yields at about <0.25. One skilled in the art can choose an appropriate light source for the photolytic process, depending on the particular type of water and the compounds it contains (e.g., hardness ions, organic materials, etc.). Some compounds entrained in water can actually assist in forming OH radicals by the absorption of UV light. It is generally believed that UV absorption for water in the wavelength range of from about 200 nm to about 300 nm is mainly due to organic matter, while common inorganic salts (except transition metal ions) have significant absorption only for wavelengths shorter than 250 nm. Nitrate has strong absorption around 210 nm. Sodium has strong absorption around 589 nm.

Without being bound by any theory, it is believed that by adding ozone or hydrogen peroxide (H₂O₂) to water, one can obtain enhanced production of OH-radicals by the reactions:

hv+O₃→O.+O₂

O.+H₂O→2.OH

hv+H₂O₂→2.OH

In some instances, H₂O₂ can be generated by a UV-ozone reaction:

hv+O₃+H₂O→O₂+H₂O₂,

thus further increasing the OH radical production.

Analogous to the radiolysis and photolysis processes described above, .OH, .H, e⁻_{aq}, and H₂O₂ can be generated by the energetic electrons in a plasma or electrical discharge in water or water vapor. One concept for this sort of process is to flow water down a grounded metal ramp which has an array or arrays of needles (or other sharp points) facing the water. The needles are typically connected to a high voltage source and enhancement of the electric field at the points produces electrical corona discharge (a form of non-equilibrium plasma), which contains electrons of sufficient energy to dissociate water molecules. Another method is to spray water through an array of fine wires (alternately connected to ground and high voltage), which also produces corona discharges similar to that described above. Another method is to immerse electrodes directly into water and produce electrical discharges in the bulk liquid.

As stated above, methods of the present invention include precipitating metallic ions in aqueous solutions as a metallic carbonates. In some embodiments, methods of the invention are used to remove hardness ions or any other metallic ions that form a relatively non-soluble metallic carbonates. Many metallic carbonates are insoluble in water, i.e., they have solubility constants (Kₛₚ) of less than 1×10⁻³ or more often 1×10⁻⁴. In general, group II carbonates (e.g., Ca, Mg, Sr, and Ba) are insoluble. Some other insoluble carbonates include FeCO₃ and PbCO₃. Table 1 below shows some of the representative solubility constants of metallic carbonates in pure (or neutral pH) water at 25° C.

TABLE 1
Kₛₚ of some of the metallic carbonates at ambient atmosphere.

| Compound | Formula | Ksp (25° C.) |
|---|---|---|
| Barium carbonate | BaCO₃ | 2.58 × 10⁻⁹ |
| Cadmium carbonate | CdCO₃ | 1.0 × 10⁻¹² |
| Calcium carbonate (calcite) | CaCO₃ | 3.36 × 10⁻⁹ |
| Calcium carbonate (aragonite) | CaCO₃ | 6.0 × 10⁻⁹ |
| Cobalt(II) carbonate | CoCO₃ | 1.0 × 10⁻¹⁰ |
| Iron(II) carbonate | FeCO₃ | 3.13 × 10⁻¹¹ |
| Lead(II) carbonate | PbCO₃ | 7.40 × 10⁻¹⁴ |
| Lithium carbonate | Li₂CO₃ | 8.15 × 10⁻⁴ |
| Magnesium carbonate | MgCO₃ | 6.82 × 10⁻⁶ |
| Magnesium carbonate trihydrate | MgCO₃•3H₂O | 2.38 × 10⁻⁶ |
| Magnesium carbonate pentahydrate | MgCO₃•5H₂O | 3.79 × 10⁻⁶ |
| Manganese(II) carbonate | MnCO₃ | 2.24 × 10⁻¹¹ |
| Mercury(I) carbonate | Hg₂CO₃ | 3.6 × 10⁻¹⁷ |
| Neodymium carbonate | Nd₂(CO₃)₃ | 1.08 × 10⁻³³ |
| Nickel(II) carbonate | NiCO₃ | 1.42 × 10⁻⁷ |
| Silver(I) carbonate | Ag₂CO₃ | 8.46 × 10⁻¹² |
| Strontium carbonate | SrCO₃ | 5.60 × 10⁻¹⁰ |
| Yttrium carbonate | Y₂(CO₃)₃ | 1.03 × 10⁻³¹ |
| Zinc carbonate | ZnCO₃ | 1.46 × 10⁻¹⁰ |
| Zinc carbonate monohydrate | ZnCO₃•H₂O | 5.42 × 10⁻¹¹ |

It is apparent from Table 1 that carbonates in general form insoluble salts with Group II metals and various transition metals. However, most carbonates of Group IA (i.e., alkali) metals, such as sodium and potassium but not lithium carbonate (see Table 1), are considered to be soluble in water (i.e., have Kₛₚ of about 1×10³ or higher, and often about 1×10⁻² or higher). Some methods of the invention take advantage of this relative insolubility of carbonate ion by reacting the carbonate ions with metallic ions to produce a metallic carbonate precipitate. By precipitating out metallic ions as metallic carbonates, methods of the invention effectively reduce the amount of dissolved metallic ions in aqueous solutions. In some embodiments of the invention, the dissolved metallic ions in the aqueous solution comprise hardness ions, such as calcium ions, magnesium ions, manganese ions, barium ions, strontium ions, or a combination thereof.

In other embodiments, methods of the invention can be used to remove any dissolved metallic ions in which the corresponding metallic carbonate has the Kₛₚ value of about 1×10⁻³ or less, often about 1×10⁻⁵ or less, and more often about 1×10⁻⁶ or less, at standard temperature and pressure (“STP”, i.e., at 1 atmosphere of pressure at 25° C.).

In some embodiments of the invention, aqueous solutions to be treated are contacted directly with carbon dioxide. In this manner, when carbon dioxide is brought in contact with the aqueous solution under appropriate conditions, metallic ions form metallic carbonate precipitate, thereby removing metallic ions from the aqueous solution. It should be appreciated, however, that the step of dissolving carbon dioxide in an aqueous solution to generate carbonate ion and treating the aqueous solution can occur in stepwise fashion. And the scope of the present invention includes all methods for precipitating metallic carbonates from the aqueous solution.

While methods of the invention include removing any metallic ions that form a metallic carbonate precipitate, for the sake of brevity and clarity the present invention will now be described in reference to removing calcium ion from the aqueous solution.

As shown in Table 1 above, calcium carbonate is poorly soluble (i.e., insoluble) in pure water. The equilibrium of its dissolving is given by the equation (with dissolved calcium carbonate on the right):

CaCO₃₍ₛ₎ [symbol] Ca⁺²+CO₃⁻² Kₛₚ=3.36×10⁻⁹ to 6.0×10⁻⁹ at 25° C.

where the solubility constant Kₛₚ depends on the nature of solid calcium carbonate. It should be appreciated that this equation is a simplified form in that other factors need to be considered when calculating a true solubility constant of calcium carbonate for a given condition. For example, some of the CO₃²⁻ combines with H⁺ in the solution according to the equation:

HCO₃ [symbol] H⁺+CO₃² Kₐ₂=5.61×10¹¹ at 25 ° C.

And calcium bicarbonate (Ca(HCO₃)₂) is many times more soluble in water than calcium carbonate.

Some of the HCO₃ combines with H⁺ in solution according to the equation:

H₂CO₃ [symbol] H⁺+HCO₃⁻Kₐ₁=2.5×10⁻⁴ at 25° C.

Some of the H₂CO₃ dissociate into water and dissolved carbon dioxide according to the equation:

H₂O+CO_{2(dissolved)} [symbol] H₂CO₃ Kₕ=1.70×10-3 at 25° C.

And dissolved carbon dioxide is in equilibrium with atmospheric carbon dioxide according to the equation:

P_{CO2}/[CO₂]=Kₕ

where K_{b} (also known as Henry constant)=29.76 atm/(mol/L) at 25 ° C., and P_{CO2} is the partial pressure of CO₂.

For ambient air, P_{CO2} is around 3.5×10⁻⁴ atmospheres (i.e., 35 Pascal). The last equation above fixes the concentration of dissolved CO₂ as a function of P_{CO2}, independent of the concentration of dissolved CaCO₃. At one atmosphere partial pressure of CO₂, the dissolved CO₂ concentration is about 1.2×10⁻⁵ moles/liter. The equation before that fixes the concentration of H₂CO₃ as a function of [CO₂]. For [CO₂]=1.2×10⁻⁵, it results in [H₂CO₃]=2.0×10⁻⁸ moles per liter. When [H₂CO₃] is known, the remaining three equations together with the reaction below:

H₂O [symbol] H⁺+OH⁻ K=10⁻¹⁴ at 25° C.

(which is true for all aqueous solutions), and the fact that the solution must be electrically neutral (represented by the relation below),

2[Ca⁺²]+[H⁺]=[HCO₃⁻]+2[CO₃⁻²]+[OH⁻]

makes it possible to solve simultaneously for the remaining five unknown concentrations. It should be appreciated that the above form of the neutrality equation is valid for water at a neutral pH solution; in the case where the original water solvent pH is not neutral, the equation must be modified accordingly.

Table 2 below shows the calcium ion solubility and the concentration of H⁺ (in the form of pH) as a function of ambient partial pressure of CO₂ (Kₛₚ=4.47×10⁻⁹).

TABLE 2
Calcium ion solubility as a function
of CO₂ partial pressure at 25° C.

| P_{CO2} (atm) | pH | [Ca⁺²] (mol/L) |
|---|---|---|
| 10⁻¹² | 12.0 | 5.19 × 10⁻³ |
| 10⁻¹⁰ | 11.3 | 1.12 × 10⁻³ |
| 10⁻⁸ | 10.7 | 2.55 × 10⁻⁴ |
| 10⁻⁶ | 9.83 | 1.20 × 10⁻⁴ |
| 10⁻⁴ | 8.62 | 3.16 × 10⁻⁴ |
| 3.5 × 10⁻⁴ | 8.27 | 4.70 × 10⁻⁴ |
| (ambient air) | | |
| 10⁻³ | 7.96 | 6.62 × 10⁻⁴ |
| 10⁻² | 7.30 | 1.42 × 10⁻³ |
| 10⁻¹ | 6.63 | 3.05 × 10⁻³ |
| 1 | 5.96 | 6.58 × 10⁻³ |
| 10 | 5.30 | 1.42 × 10⁻² |

As Table 2 shows, at atmospheric levels of ambient CO₂, the solution becomes slightly alkaline. And as more CO₂ gas is present (i.e., at higher CO₂ partial pressure), dissolved carbon dioxide forms carbonic acid, thereby decreasing the pH of the aqueous solution. Accordingly, larger amounts of base are required at higher CO₂ partial pressure to convert the dissolved carbon dioxide into carbonate.

Although “insoluble” (i.e., Kₛₚ<1×10⁻³) in water, calcium carbonate dissolves in acidic solutions. The carbonate ion behaves as a Bronsted base.

CaCO₃₍ₛ₎+2H⁺_{(aq)}→Ca⁺²_{(aq)}+H₂CO_{3(aq)}

And in acidic solution, the aqueous carbonic acid dissociates, producing carbon dioxide gas.

H₂CO_{3(aq)} [symbol] H₂O₍₁₎+CO_{2(g)}

Therefore, one needs to consider the various equilibria when attempting to precipitate out carbonate ions as a metallic carbonate solid. Thus, in many embodiments of the invention, the pH of the aqueous solution is adjusted to favor formation of carbonate ions, and hence formation of a metallic carbonate precipitate. Typical pH of the aqueous solution that favors formation of the metallic carbonate precipitate has been disclosed above.

Carbonates of other metallic ions present similar properties. Thus, regardless of the particular dissolved metallic ion(s) in the aqueous solution, similar consideration of pH, temperature, and pressure is employed. Typically, at lower temperatures higher precipitates of carbonates are formed. In some embodiments, the expansion (endothermic) of solid or liquid CO₂ can be used efficiently in the process to chill or cool the aqueous solution that is used to dissolve CO₂.

While methods of the invention can be used to treat any aqueous solution that comprises dissolved metallic ions that form metallic carbonate precipitates, methods of the invention are typically used to treat aqueous solution having dissolved metallic ions that form metallic carbonates having Kₛₚ of about 10², often about 10³, more often about 10⁴, and still more often about 10⁻⁵. Typically, at least about 50%, often at least about 70%, more often at least about 90%, and still more often at least about 95% of dissolved metallic ions that form metallic carbonates of having Kₛₚ described herein are removed by the methods of the invention.

It has been found by the present inventors that many natural water sources and industrial waste waters comprise various concentrations of metallic ion(s) that are suitable for methods of the invention. For example, industrial process water (such as water from oil refinery process), some natural aquifers, sea water, oil field produced water, and frac flowback water contain various amounts of calcium ions, and in many instances other metallic ion(s) that can form a precipitate with carbonate ions. Thus, in many embodiments of the invention, the aqueous solution that is treated by methods of the invention comprises industrial process water, water from an aquifer, sea water, oil field produced water, frac flowback water, or a combination thereof.

In many instances, the aqueous solution that is treated by methods of the invention comprises other materials, for which their removal is often desirable. For example, frac flowback, produced water and sea water can contain a large amount of chloride ions. Chloride ions in water are typically removed by filtration such as reverse osmosis or distillation. Another method to remove chloride is by conversion to chlorine gas by electrolysis. Electrolysis of chloride ions also produces hydrogen gas and hydroxides from water. Accordingly, methods of the present invention can be advantageously employed by using the hydroxides that are generated from the electrolysis to adjust the pH in order to facilitate carbonate ion formation from carbon dioxide. In this manner, it is possible to reduce or even to eliminate any need for adding a hydroxide source to achieve the desired pH level for conversion of dissolved carbon dioxide to carbonate ions. Furthermore, the hydrogen gas that is generated can be used as a fuel source to reduce the overall energy consumption.

While methods of the invention are suitable for using carbon dioxide from any source, it is more advantageous to use carbon dioxide that is generated from industrial processes. Exemplary industries that produce a significant amount of carbon dioxide that can be used to treat water include, but are not limited to, the energy industry (such as oil refineries, the coal industry, and power plants), cement plants, and the auto, airline, mining, food, lumber, paper, and manufacturing industries.

Additional objectives, advantages, and novel features of this invention will become apparent to those skilled in the art upon examination of the following examples thereof, which are not intended to be limiting.

### Examples

### Example 1

Source waters from three separate oil & gas geological basins having different levels of metallic ions were evaluated and treated (Barnett Shale, Piceance and Denver Julesburg). See Table I. Hardness ions are considered to be calcium, magnesium, strontium, manganese, barium, iron, copper, and other metallic ions which readily form insoluble carbonate compounds.

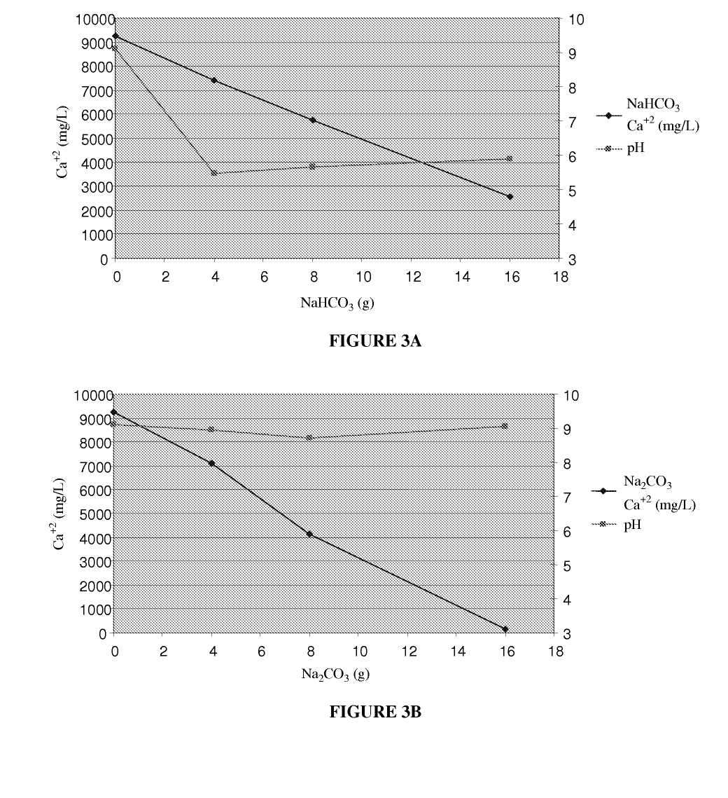

Barnett Shale water samples were treated with NaHCO₃ and soda ash Na₂CO₃. The amount of calcium ion concentration decreased significantly as the amount of sodium bicarbonate and sodium carbonate addition increased as shown in FIGS. 3A and 3B.

Experiments were conducted using pressurized CO₂ as the carbonate source instead of adding solid sodium bicarbonate or sodium carbonate.

Experiments were conducted on Barnett Shale water and Piceance Basin water using water which had been carbonated with CO₂ and then dosed with NaOH. Test results are shown below:

TABLE 1
Basin Water Starting and Ending Characteristics

| | Starting | Ending | |
|---|---|---|---|
| Source of | Total | Total | Drinking |
| Water | Hardness | Hardness | Water Std* |
| Barnett Shale | 23,000 mg/L | 350 mg/L | 500 mg/L |
| Piceance Basin | 3,000 mg/L | 150 mg/L | 500 mg/L |

*500 mg/L is generally accepted as an upper limit for Total Hardness in Drinking Water

Produced water from the Denver Julesburg Basin was treated. This experiment forced carbonated water (Dissolved CO₂ provided in-situ source of carbonate ions according to Equation 3) at 3 discrete pressure levels (2.5, 4.0 & 10 psi) and treat with 4 discrete amounts of NaOH (3, 5, 7 & 9 grams). This process caused the precipitation of the above listed insoluble metallic carbonates. The response variables are pH, Total Alkalinity (mg/L) and Total Hardness (mg/L). pH was measured with a Hach calibrated pH probe and Alkalinity and Hardness were measured using industry standard Hach titration methods.

A statistical model was developed to predict the 3 response variables (pH, Total Hardness, Total Alkalinity) from the 2 input variables (CO₂ pressure, NaOH concentration). Concentrations of carbonic acid and hydroxide ions was varied with 3 separate pressure settings for CO₂ (2.5, 4.0 & 10 psi) and 4 separate concentration levels with NaOH (3, 5, 7 & 9 grams).

Equations 1 & 2 describe the first two steps in the equilibrium relationships of dissolved CO₂ in water. And equation 3 describes the reaction of a hydroxide source with carbonic acid to form free carbonate ions in solution. Equation 4 describes the formation of insoluble metallic carbonates.

CO2 Dissolves in Water CO₂(g)→CO₂(aq) Equation 1:

CO2 Reacts with Water to form Carbonic Acid CO₂(aq)+H₂O [symbol] H₂CO₃ Equation 2:

Hydroxide Reacts with Carbonic Acid to form Carbonate Ions 2NaOH+H₂CO₃→2Na⁺+2H₂O+CO₃²⁻ Equation 3:

Formation of Insoluble Metallic Carbonate Precipitates Equation 4:

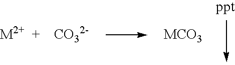

### Experimental Procedure:

The following is a standard experimental protocol that was used to determine the effectiveness of hardness ion removal from various water sources:
Step 1: Measure & record starting pH, Total Hardness & Total Alkalinity of water to be treated.
Step 2: Weigh out 4 discrete masses of NaOH (3, 5, 7, 9 grams), place in 4 separate reaction vessels.
Step 3: Set CO₂ pressure to 1^{st} pressure level.
Step 4: Process produced water containing hardness ions through a soda fountain carbonation pump.
Step 5: Fill buckets to 4-gal mark with carbonate produced water.
Step 6: Wait for precipitation process to complete (complete settling of floc).
Step 7: Sample about 1 L of each bucket, process through vacuum filter to remove floc.
Step 8: Measure and record pH, Total Hardness and Total Alkalinity for each sample.
Step 9: Reset pressure of CO₂ to next discrete level.
Step 10: Repeat Steps 1-6.
Step 11: Reset pressure of CO₂ to next discrete level.
Step 12: Repeat Steps 1-6.

### Experimental Results:

The following table shows the results of hardness ion reduction using the experimental protocol above.

| | | | Total | |
|---|---|---|---|---|
| CO₂ Pressure | NaOH | Total Hardness | Alkalinity | |
| (psi) | Concentration (g) | (mg/L as CaCO₃) | (mg/L) | pH |
| 0 (Blank) | 0 | 1150 | 232 | 7.65 |
| 2.5 | 3 | 1040 | 1150 | 8.21 |
| 2.5 | 5 | 230 | 810 | 9.16 |
| 2.5 | 7 | 105 | 1270 | 10.4 |
| 2.5 | 9 | 35 | 1720 | 11.5 |
| 4.5 | 3 | 595 | 790 | 7.66 |
| 4.5 | 5 | 385 | 1125 | 7.87 |
| 4.5 | 7 | 175 | 1400 | 8.72 |
| 4.5 | 9 | 125 | 1280 | 9.66 |
| 10 | 3 | 575 | 740 | 7.93 |
| 10 | 5 | 295 | 1010 | 8.13 |
| 10 | 7 | 185 | 1590 | 8.72 |
| 10 | 9 | 140 | 1900 | 9.15 |

### Graphs and Statistical Data Analysis

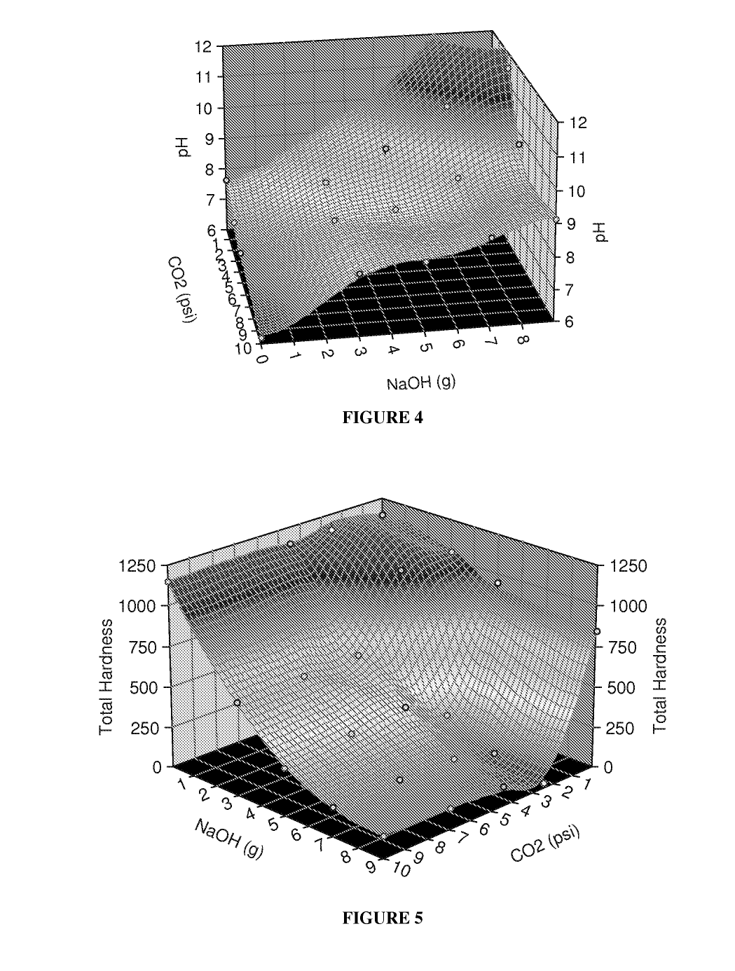

The pH data fit very well to a Cosine Series Bivariate Order 3 equation with resulting r² of 0.996 and Fit Standard Error of 0.131. The F-Statistic of 173 high level of significance to the fit. See FIG. 4. The surface showed a saddle point near NaOH˜3 grams and CO₂˜3-4 psi.

The fit statistics are presented below:

| r² Coef Det | DF Adj r² | Fit Std Err | F-value |
|---|---|---|---|
| 0.9961798356 | 0.9885395067 | 0.1319368309 | 173.84589124 |

| Parm | Value | Std Error | t-value | 95.00% Confidence Limits | | P > \|t\| |
|---|---|---|---|---|---|---|
| a | 8.483690365 | 0.095074931 | 89.23162285 | 8.25105039 | 8.71633034 | 0.00000 |
| b | 0.961118065 | 0.066566195 | 14.43853089 | 0.798236453 | 1.123999676 | 0.00001 |
| c | −1.42117145 | 0.048156256 | −29.511668 | −1.53900556 | −1.30333733 | 0.00000 |
| d | 0.572220362 | 0.052499729 | 10.89949169 | 0.443758153 | 0.700682572 | 0.00004 |
| e | −0.6990775 | 0.086295779 | −8.10094653 | −0.91023566 | −0.48791933 | 0.00019 |
| f | 0.066050586 | 0.043797239 | 1.50809931 | −0.0411174 | 0.173218569 | 0.18226 |
| g | 0.137724203 | 0.130901464 | 1.052121182 | −0.18258014 | 0.458028545 | 0.33326 |
| h | −0.43301684 | 0.077007288 | −5.62306315 | −0.62144689 | −0.2445868 | 0.00135 |
| i | 0.288456411 | 0.061342643 | 4.702379929 | 0.138356372 | 0.43855645 | 0.00332 |
| j | −0.3059942 | 0.043160168 | −7.0897361 | −0.41160333 | −0.20038508 | 0.00040 |

FIG. 5 is a graph that shows a fit using a Lowess curve smoothing algorithim. However, the nature of the surface is appearant from this technique. As can be seen from the surface, there is a trough in the surface located where CO₂ psi˜3-3.5 psi and NaOH˜5 grams.

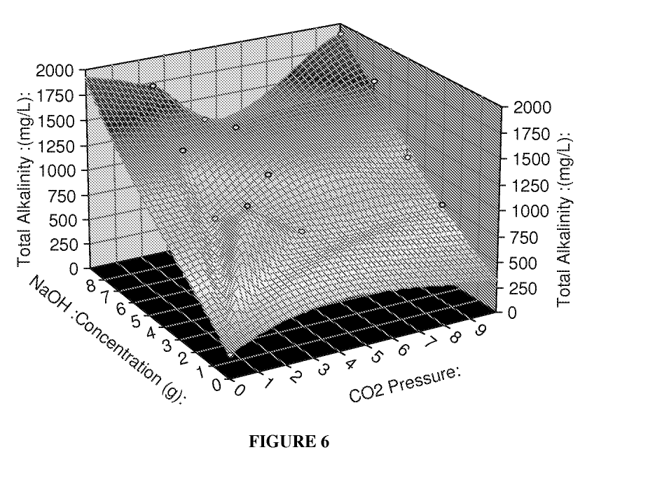

FIG. 6 is a graph that shows a fit using a Lowess curve smoothing algorithim. However, the nature of the surface is appearant from this technique. Also, it is appearant that Total Alkalinity and Total hardness are inverses of each other, e.g., as Total Hardness is reduced, Total Alkalinity is increased.

As can be seen, there is a local minima where CO₂ psi˜3.5 psi and NaOH˜3-4 grams. This point appears to be the optimal setting to achieve the desired goals of neutral pH, Total Hardness <500 mg/L and Total Alkalintiy <600 mg/L for this water sample.

Analysis of the graphs showed that a process near CO₂ pressure of about 3.0 psi, NaOH amount of about 4.5 grams results in pH of about pH 8.0, total hardness of about 500 mg/L or less and total alkalinity of about 600 mg/L or less. Such results are similar to drinking water standards (See Table 1 above).

Pressurized CO₂ and Hydroxide treatment of high hardness water resulted in significant reduction of hardness ion concentrations (Total Hardness) with minimal increase in pH and Alkalinity when optimized input variables are used. The process can be used to remove the concentrations of hardness ions present in the water to be treated.

### Example 2

The Corona Discharge was produced through a needle apparatus. For these experiments a single needle was used. However, for treating a large volume of water, multiple needles resistively coupled in parallel can be used. It is believed that Corona Discharge produces OH⁻, OH radicals, and other ions in-situ. These ions react with the hardness ions, Ca²⁺, Mg²⁺, Sr²⁺, to produce hydroxides, Ca(OH)₂, Mg(OH)₂, and Sr(OH)₂. These hydroxides are insoluble in water and precipitate out. Under standard conditions, the solubility of these hydroxides are: Ca(OH)₂ is 0.185 g per 100 mL; Mg(OH)₂ is 0.0012 g per 100 mL; and Sr(OH)₂ is 1.77 g per 100 mL. Thus, by forming hydroxides and precipitating out these metal ions, the corona discharge reduces the overall hardness of the water. This experiment examines whether enough OH was produced by corona discharge to soften the water and quantifies the amount or percentage of hardness ion reduction.

The corona discharge for this experiment utilized a Franceformer 15000V Neon Transformer, a 10A-120 volt Variable Autotransformer, a full wave rectifying HV07-15 diode bridge, a pure ⅛ inch tungsten welding rod, aluminum foil, a 250 mL beaker, and high voltage wire.

Each test consisted of a Calcium Hardness titration, unless Magnesium was present then the solution was additionally titrated for Total Hardness, a pH reading, a Conductivity reading, a Voltage reading, and a current reading. The titrations were done with a Hach digital titrator and Hach test kits. These test kits are easily found on Hach's website. See www.hach.com. The pH was measured using a Thermo Scientific Orion Ross Sure-Flow pH probe with a Hach SenseIon 3 meter. Conductivity was measured using a Hach CDC401 IntelliCAL Standard Conductivity probe. Voltage was measured using a Tektronix TDS2014B Oscilloscope and a Tektronix 1000× high voltage probe. The current was measured using a Wide Band Current Transformer.

Briefly, the set-up for corona discharge is as follows: The variable auto transformer (15 kV neon transformer) was connected the wall outlet. From the transformer, one end was connected to one side of the HV07-15 diode bridge, while the other end of the transformer was attached to the other side of the diode bridge. The diode bridge connected the neon transformer to the tungsten electrode and the aluminum foil strip. The high voltage probe was attached to the tungsten rod, and the current transformer was attached to the outgoing cable of the neon transformer.

Three experiments were conducted. The first experiment contained a solution of 2.2159 grams of Calcium Chloride (CaCl₂) in 200 mL distilled water. The solution was placed in a 250 mL beaker. An aluminum foil strip was placed into the solution. The tungsten rod was suspended over the solution by a lab stand. The tungsten rod was powered with the full wave rectified diode bridge to be positive (+). This effect caused a (+) corona discharge. For this experiment, the voltage going to the tungsten rod read 1.78 kV. This was achieved through adjusting the variac to the appropriate power setting. However, before turning on the power, calcium hardness, pH, and conductivity were measured. The calcium hardness was measured using Hach's Calcium Hardness titration kit and a Hach digital titrator. The pH was measured with the Thermo Scientific Orion Ross Sure-Flow pH probe. The conductivity was measured with the Hach CDC401 IntelliCAL Standard Conductivity probe. With the initial measurements taken, the experiment began. The tungsten rod was placed above the solution and power given to the system. After 1 hour, the system was shut off. The solution was filtered and the final volume was measured. Using the filtrate, final measurements were taken and % hardness removal was calculated.

The second experiment included a solution with only 0.4434 grams of CaCl₂ in 200 mL of distilled water. The same procedure as above was utilized. Measurements were gathered before and after the corona discharge took place.

The third experiment included 2.2126 grams of CaCl₂ in 200 mL of distilled water. The same procedure as above was used except that in this experiment run time was only 15 minutes instead of an hour.

Two additional experiments were conducted. The first consisted of AC power, no diode bridge, with 2.2156 grams CaCl₂ in 200 mL of distilled water. The same procedure as described above was performed. Initial measurements were taken before the corona discharge. The experiment lasted 15 minutes. Then the final measurements were taken.

Another experiment included a 200 mL sample of Barnett shale water. Barnett Shale water contains both magnesium and calcium. Thus, Total Hardness and Calcium Hardness were measured through titrations. The same procedure as described above was performed. Measurements were taken before and after the corona discharge. The experiment ran for 15 minutes.

The final experiment was conducted using a 200 mL sample of Barnett Shale water. However, for this experiment, the solution was filtered before measurements were performed. This was to remove any suspended solids. After the first filtering, the initial hardness levels were measured. Then the solution was exposed to the corona discharge for 15 minutes. After the corona discharge, another set of titrations were conducted. Then the solution was filtered, and the post-filter measurements were taken. With the post-filter measurements, the solution was run under the corona discharge for a second time. After another 15 minutes, another set of measurements were taken. The solution was then filtered, and final measurements were taken. This experiment was to show that a step wise approach would remove hardness after every run through the corona discharge.

### Results

Data was gathered by calculating the mass of the hardness ions, Ca²⁺ and Mg²⁺, through stoichiometry. Each test consisted of a titration number based on mg/L of Ca²⁺. The first test contained an initial titrated calcium (Ca²⁺) hardness value of 3540 mg/L. This number is then converted to grams of Ca²⁺. The stoichiometry is shown below.

$$3540 mg / L \{ {Ca}^{2 +} \} \times 0.200 L \times \frac{1 g}{1000 mg} = 0.7080 g \{ {Ca}^{2 +} \} \qquad ( 1 )$$

This gave the amount of Ca²⁺ in solution. After the experiment was completed, another titration for calcium hardness was performed yielding a value of 3752 mg/L Ca²⁺, which is equal to 0.6679 g of Ca²⁺:

$$3752 mg / L \{ {Ca}^{2 +} \} \times 0.178 L \times \frac{1 g}{1000 mg} = 0.6679 g \{ {Ca}^{2 +} \} \qquad ( 2 )$$

With these numbers, the total amount of calcium reduction was calculated. Thus, 0.0401 g of Ca²⁺ was removed using the corona discharge. The precipitate formed was Ca(OH)₂. Without being bound by any theory, it is believed that OH⁻ and OH radicals produced by corona discharge reacted with Ca²⁺ to form Ca(OH)₂. Thus, the percentage of Ca²⁺ removal using the corona discharge was 5.67%. In all subsequent experiments, the mass and percentages were also calculated. The below table shows the results obtained using the procedure described above.

TABLE
Masses compared to Experiments and the
correlating % of Hardness Reduction

| | Pre-Treatment | Post-Treatment | % Hardness |
|---|---|---|---|
| Experiment | Mass (g) | Mass (g) | Reduction |
| Test 1 | 0.7080 | 0.6679 | 5.6010 |
| Test 2 | 0.1438 | 0.1320 | 8.2481 |
| Test 3 | 0.7320 | 0.6443 | 11.9836 |
| AC Test | 0.7520 | 0.6582 | 12.4681 |
| BS Ca²⁺ | 1.8800 | 1.5288 | 18.6809 |
| BS Mg²⁺ | 0.3157 | 0.2652 | 16.0000 |
| BS Step 1 Ca²⁺ | 1.8520 | 1.7410 | 6.0108 |
| BS Step1 Mg²⁺ | 0.2000 | 0.1340 | 33.0909 |
| BS Step2 Ca²⁺ | 1.7410 | 1.5030 | 13.6473 |
| BS Step2 Mg²⁺ | 0.1340 | 0.1350 | −0.8831 |
| BS Total Step-wise Ca²⁺ | 1.8520 | 1.5030 | 18.8380 |
| BS Total Step-wise Mg²⁺ | 0.2000 | 0.1350 | 32.5000 |

BS = Barnett Shale water

According to the table, it can be seen that the percentage of hardness reduced is from 5.601% to 18.838% for Ca²⁺. For Magnesium, one test showed a 16.0% reduction, while the Barnett Shale Step-wise test showed a decrease in 33.09%. Interestingly, the second step of the Step-wise experiment showed a slight increase in Mg²⁺ concentrations. The reason for this increase is unknown for this deviation. However, it can be seen that hardness was decreased as precipitate formation was observed during the second step.

### Discussion

The data show that dissolved metallic ions in water were removed by corona discharge. The percentage of hardness removed ranged from 5% to 18% for Ca²⁺, and about 16% to 32% for Mg²⁺. The formation of precipitates, Ca(OH)₂ and Mg(OH)₂, shows that the corona discharge produced hydroxide, and OH radicals in-situ. A higher production of hydroxide using corona discharge can be achieved, for example, by using a higher voltage, more electrodes, longer exposure to corona discharge, etc. In addition, a UV lamp can be used in conjunction with corona discharge to increase the amount of hydroxide formation by dissociating hydrogen peroxide, H₂O₂ that is formed by the corona discharge.

### Example 3

Barnett Shale water is extremely hard water coming from Texas. See Table 1 in Example 1. It includes a large amount of the following ions sodium, calcium, strontium, magnesium, potassium, barium, ferrous iron, aluminum, chloride, bicarbonate, and sulfate. Because of the quality of Barnett Shale water, it cannot be used for fracing due to scaling. An experiment was conducted to remove these hardness ions, which included adding baking soda (sodium bicarbonate, NaHCO₃) and raising the pH, as well as adding soda ash (sodium carbonate, Na₂CO₃) in a step wise fashion.

### Experimental

Conductivity and pH measurements of Barnett Shale water were taken initially using a Hach CDC401 IntelliCAL Standard Conductivity probe connected to a Hach HQ 40d meter and a Thermo Scientific Orion Ross Sure-Flow pH probe connected to a Hach SenseIon3 pH meter, respectively. Total hardness and calcium hardness were determined using Hach methods 8213 and 8204, respectively. The calcium hardness titration allowed one to determine calcium hardness as CaCO₃ in mg/L. This can be converted to ionic calcium concentration.

The total hardness titration allowed one to determine the concentration of all hardness ions, including calcium, as CaCO₃. Since this method did not allow for determination of individual concentrations of hardness ions, except for magnesium, other hardness ions such as strontium or iron are included in the concentration of the calcium hardness. Magnesium hardness was determined by subtracting the calcium hardness concentration from the total hardness concentration. Once magnesium hardness (as MgCO₃) has been determined it can be converted to ionic magnesium concentration.

After determining the concentration of ionic calcium and magnesium, the stoichiometric amount of baking soda was determined, verified, and measured. The appropriate amount of baking soda was then added to 200 mL of Barnett Shale water. Immediately a precipitate formed, which was removed by filtration. The pH and conductivity of the filtrate were measured, and the concentrations of ionic calcium and magnesium were confirmed.

Two other solutions were prepared in a similar manner as described above. However, instead of filtering after additions and dilutions of baking soda, the pH of one solution was raised to about 10.50 and the other to a pH of about 12.00. These solutions were then filtered and the pH, conductivity, ionic calcium concentration (i.e., total hardness ion concentration minus magnesium ion concentration), and ionic magnesium concentration were determined. Referring again to FIG. 1, at pH of approximately 10.50 the ratio of bicarbonate to carbonate is about 0.5, i.e., about 50% exists as bicarbonate and about 50% exists as carbonate. At a pH of 12.00, almost 100% exists as carbonate. It should be appreciated that calcium carbonate is a substantially insoluble solid whereas calcium bicarbonate has a significantly higher solubility.

The experiment with soda ash was performed in a similar manner as the baking soda experiment, with the same instrumentation, except that the pH of the solution was not altered. A stoichiometric amount of soda ash was added to 200 mL of Barnett Shale water, which formed a precipitate similar to the baking soda experiment. The precipitate was filtered. The filtrate was titrated for calcium and magnesium, and the pH and conductivity were determined. Another stoichiometric amount of soda ash was added to the filtrate. Once again the precipitate that was formed was filtered. The second filtrate was titrated for calcium and magnesium, and the pH and conductivity were once again determined.

### Results

### Baking Soda

The initial pH of the Barnett Shale water was 7.21, the conductivity was 141.0 mS/cm, calcium hardness was 21,000 mg/L, and the total hardness was 26,000 mg/L. From the calcium and total hardness data, it was determined that ionic calcium and ionic magnesium concentrations were 8409 mg/L and 1214 mg/L, respectively. After adding 4.3763 g of baking soda to 200 mL of Barnett Shale water, the pH dropped to 5.96 while the conductivity increased from 141.0 mS/cm to 141.1 mS/cm. This mixture of baking soda and Barnett Shale water formed a precipitate almost immediately, which was filtered. The precipitate had a mass of 1.7933g. Following the filtration, the pH of filtrate was measured to be 5.97 and a conductivity was measured at 142.3 mS/cm. It was determined that the ionic calcium and magnesium concentrations decreased to 5400 mg/L and 729 mg/L, respectively. Thus, the amount of calcium and magnesium reduction was 35.78% and 39.95%, respectively. The data and results for the baking soda experiment without pH adjustment are shown in the Table below.

Baking Soda and Barnett Shale Water without pH Adjustment

| | Barnett | Barnett Shale | Post |
|---|---|---|---|
| Measurement | Shale | and Baking Soda | Filter |
| pH | 7.21 | 5.96 | 5.97 |
| conductivity (mS/cm) | 141.00 | 141.10 | 142.30 |
| Total Hardness as CaCO₃ | 26000.00 | N/A | 16500.0 |
| (mg/L) | | | |
| Calcium Hardness as | 21000.00 | N/A | 13500.0 |
| CaCO₃ (mg/L) | | | |
| [Ca²⁺] (mg/L) | 8409.00 | N/A | 5400.00 |
| [Mg²⁺] (mg/L) | 1214.00 | N/A | 729.00 |
| Volume of Barnett Shale | 200.00 | 200.00 | 200.00 |
| (mL) | | | |
| Mass of filter paper (g) | N/A | N/A | 1.78 |
| Mass of filter paper and | N/A | N/A | 3.57 |
| precipitation (g) | | | |
| Mass of precipitation (g) | N/A | N/A | 1.79 |
| Mass of baking soda (g) | N/A | 4.38 | N/A |
| % reduction in [Ca²⁺] | N/A | N/A | 35.78 |
| % reduction in [Mg²⁺] | N/A | N/A | 39.95 |

After adding the baking soda (4.3661 g) to 200 mL with Barnett Shale water, the pH dropped from 7.211 to 5.74, and conductivity increased from 141.00 mS/cm to 143.40 mS/cm.

The solution that was brought to a pH of 10.5 had a conductivity of 95.20 mS/cm after filtration. The ionic calcium and magnesium was found to have decreased from 8409 mg/L and 1214 mg/L to 1612 mg/L and 77.76 mg/L, respectively, which is 80.83% and 93.59% reduction, respectively. The mass of the precipitate recovered was discovered to be 4.52 g.

The solution whose pH was adjusted to 12.0 had a conductivity of 95.70 mS/cm after filtration. The amount of calcium and magnesium ions was found to decrease from 8409 mg/L and 1214 mg/L to 1612 mg/L and 31.59 mg/L, respectively, which is 80.83% and 97.40% reduction, respectively. The mass of the precipitate recovered was 4.38 g. The data and results for the baking soda experiment with pH adjustments are shown in the following Table.

Baking Soda and Barnett Shale Water with pH Adjustment

| | | Barnett Shale + | | |
|---|---|---|---|---|
| Measurement | Barnett Shale | Baking Soda | pH | pH |
| pH | 7.21 | 5.74 | 10.51 | 12.00 |
| conductivity (mS/cm) | 141.00 | 143.40 | 95.20 | 95.70 |
| Total Hardness as CaCO₃ (mg/L) | 26000.00 | N/A | 4350.0 | 4160.0 |
| Calcium Hardness as CaCO₃ (mg/L) | 21000.00 | N/A | 4030.0 | 4030.0 |
| [Ca²⁺] (mg/L) | 8409.00 | N/A | 1612.0 | 1612.0 |
| [Mg²⁺] (mg/L) | 1214.00 | N/A | 77.76 | 31.59 |
| Volume of Barnett Shale (mL) | 200.00 | 200.00 | 200.00 | 200.00 |
| Mass of filter paper (g) | N/A | N/A | 1.60 | 5.94 |
| Mass of filter paper and ppt (g) | N/A | N/A | 5.84 | 10.33 |
| Mass of precipitation (g) | N/A | N/A | 4.52 | 4.38 |
| Mass of baking soda (g) | N/A | 4.37 | N/A | N/A |
| % reduction in [Ca²⁺] | N/A | N/A | 80.83 | 80.83 |
| % reduction in [Mg²⁺] | N/A | N/A | 93.59 | 97.40 |

The initial pH of the Barnett Shale water was 7.21, the conductivity was 141.5 mS/cm, calcium hardness was 23,000 mg/L, and the total hardness was 27,000 mg/L. From the calcium and total hardness data, it was determined that ionic calcium and ionic magnesium concentrations were 9200 mg/L and 972 mg/L, respectively. After 5.7130 g of soda ash was added to 200 mL of Barnett Shale water, the pH dropped to 6.397, while the conductivity decreased to 141.4 mS/cm. This mixture of soda ash and Barnett Shale water formed a precipitate almost immediately, which was filtered. The precipitate had a mass of 7.0206 g. Following the filtration, the filtrate had a pH of 7.4 and a conductivity of 155.1 mS/cm. It was determined that the ionic calcium and magnesium concentrations decreased to 1088 mg/L and 811.62 mg/L, respectively, which corresponds to 88.17% and 16.50% reduction, respectively.

Additional 1.1157 g of soda ash was added to the filtrate (145 mL) from the previous step. Once again, a precipitate formed (1.4693 g). This solution had a pH of 9.3 and a conductivity of 160.0 mS/cm. After filtering for the second time, the pH dropped to 9.1 and the conductivity increased to 164.4 mS/cm. Titrations for the total and calcium hardness showed that the calcium and magnesium ion concentrations decreased to 180 mg/L and 716 mg/L, respectively, which corresponds to 98.04% and 26.34% reduction, respectively. The data and results for the step-wise addition of soda ash to Barnett Shale water experiment are shown in the following Table.

Soda Ash and Barnett Shale Water: Two Step Additions

| | Barnett Shale | Step 1 | Step 1 | Step 2 | Step 2 |
|---|---|---|---|---|---|
| Measurement | Initially | Pre-filter | Post-filter | Pre-filter | Post-filter |
| pH | 7.30 | 5.74 | 7.44 | 9.28 | 9.08 |
| conductivity (mS/cm) | 141.50 | 143.40 | 155.10 | 160.00 | 164.40 |
| Total Hardness as CaCO₃ (mg/L) | 27000.00 | N/A | 6060.00 | N/A | 3400.00 |
| Calcium Hardness as CaCO₃ | 23000.00 | N/A | 2720.00 | N/A | 450.00 |
| (mg/L) | | | | | |
| [Ca²⁺] (mg/L) | 9200.00 | N/A | 1088.00 | N/A | 180.00 |
| [Mg²⁺] (mg/L) | 972.00 | N/A | 811.62 | N/A | 716.00 |
| Volume of Barnett Shale (mL) | 200.00 | 200.00 | 200.00 | 145.00 | 145.00 |
| Mass of filter paper (g) | N/A | N/A | 6.83 | N/A | 5.05 |
| Mass of filter paper and | N/A | N/A | 13.85 | N/A | 6.52 |
| precipitation (g) | | | | | |
| Mass of precipitation (g) | N/A | N/A | 7.02 | N/A | 1.47 |
| Mass of soda ash (g) | N/A | 5.71 | N/A | 1.12 | N/A |
| % reduction in [Ca²⁺] | N/A | N/A | 88.17 | N/A | 98.04 |
| % reduction in [Mg²⁺] | N/A | N/A | 16.50 | N/A | 26.34 |

### Discussion

It can be seen from the percent reduction in ionic calcium and magnesium between the baking soda and soda ash experiments, that adding baking soda to Barnett Shale water and adjusting the pH resulted in a higher amount of magnesium removal than adding carbonate. On the other hand, adding soda ash (sodium carbonate) in a step wise fashion to Barnett Shale water, as described above, was much more efficient at removing calcium than magnesium.

In the experiment where baking soda (sodium bicarbonate) was added to Barnett Shale water, hydroxides were also added via a sodium hydroxide solution. The reason such a higher reduction of magnesium was obtained compared to calcium in the same reaction or magnesium in the soda ash experiment is believed to be that magnesium hydroxide is the least soluble product formed. Therefore, in the baking soda experiment where the pH was adjusted, it is believed that magnesium was reacting with the hydroxides being added first and falling out of solution. Magnesium hydroxide has a solubility of 0.012 g/L compared to 1.85 g/L of calcium hydroxide.

In the experiment where soda ash was added to Barnett Shale water the opposite was true, in that, a greater reduction in calcium was observed than magnesium. Once again this is believed to be due to the solubility of the products that were formed. Calcium carbonate is almost an order of magnitude less soluble than magnesium carbonate. Calcium carbonate has a solubility of 0.015 g/L, while magnesium carbonate has a solubility of 0.101 g/L. Because of this difference in the solubility, it is believed that calcium carbonate forms and falls out of solution at a faster rate than magnesium carbonate resulting in a greater reduction in calcium.

### Example 4

A bottle of carbonated water that can be readily purchased was titrated for carbon dioxide concentration using Hach method 8205. It was found to have a concentration of 1824 mg/L as carbon dioxide. This concentration was then used to determine the concentration of carbonic acid by multiplying by 1.41 (the ratio of the molar mass of carbonic acid to the molar mass of carbon dioxide), which was found to be 2570.87 mg/L. Then by assuming that all of the carbonic acid could be converted to ionic carbonate by raising the pH of the solution to about 12, it was calculated that the concentration of ionic carbonate was 2487 mg/L. It should be noted that the pH and conductivity of the 100 mL sample of carbonated water solution were 3.594 and 66.2 μS/cm, respectively, and that the pH and conductivity of the carbonated water after pH adjustment were 12.004 and 4.95 mS/cm, respectively.

Using the calculated concentration of ionic carbonate, it was determined that at least 0.4599 g of calcium chloride was needed. Twice this amount (0.8940 g) was dissolved into 200 mL of distilled water so that analysis could be done and allow 100 mL left over for the actual reaction. This calcium chloride solution had pH of 9.970, a conductivity of 8.18 mS/cm, and from the Hach calcium hardness titration (method 8204) it was determined that it had a calcium harness as calcium carbonate of 3700 mg/L, which equated to a ionic calcium concentration of 1480 mg/L.

After the pH adjusted carbonated water solution and calcium chloride solution were mixed the combined solution formed a milky white precipitate immediately. This solution had a pH of 11.125 and a conductivity of 3.91 mS/cm. The mass of the filter paper prior to filtering was 5.0644 g. After filtering the solution had a pH of 9.343 and a conductivity of 4.56 mS/cm. Following another calcium hardness titration it was determined that the calcium hardness as calcium carbonate decreased to 180 mg/L, which in turn was a decrease in ionic calcium concentration to about 72 mg/L. This reduction equates to about 95% reduction in ionic calcium concentration.

By raising the pH of water and subsequently carbonating it, carbonates can be generated. This carbonate solution can then be mixed with hard water to simultaneously remove hardness and sequester carbon dioxide in the form of metallic carbonates.

| | | Carbonated | CaCl₂ | | |
|---|---|---|---|---|---|
| | Carbonated | Water After pH | Solution | Mixed | Mixed |
| Measurement | Water Initial | Adjustment | Initial | Pre-filter | Post-filter |
| pH | 3.59 | 12.00 | 9.97 | 11.13 | 9.34 |
| conductivity (μS/cm) | 66.20 | 4950.00 | 8180.00 | 3910.00 | 4560.00 |
| Carbon Dioxide (mg/L) | 1824.00 | N/A | N/A | N/A | N/A |
| Carbonic Acid (mg/L) | 2570.00 | N/A | N/A | N/A | N/A |
| Carbonate (mg/L) | N/A | 2487.00 | N/A | N/A | N/A |
| Calcium Hardness as CaCO₃ | N/A | N/A | 3700.00 | N/A | 180.00 |
| (mg/L) | | | | | |
| [Ca²⁺] (mg/L) | N/A | N/A | 1480.00 | N/A | 72.00 |
| Volume of Carbonated Water | 100.00 | 100.00 | N/A | N/A | 100.00 |
| (mL) | | | | | |
| Volume of Calcium Chloride | N/A | N/A | 100.00 | N/A | 100.00 |
| Solution (mL) | | | | | |
| Mass of filter paper (g) | N/A | N/A | N/A | 5.0644 | N/A |
| Mass of filter paper and | N/A | N/A | N/A | N/A | |
| precipitation (g) | | | | | |
| Mass of precipitation (g) | N/A | N/A | N/A | N/A | |
| Mass of Calcium Chloride (g) | N/A | N/A | 0.8940 | N/A | N/A |
| % reduction in [Ca²⁺] | N/A | N/A | N/A | N/A | 95.14 |

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for reducing the amount of a dissolved metallic ion in an aqueous solution comprising the same, said method comprising contacting the aqueous solution with carbonate ions under conditions sufficient to form a precipitate of metallic carbonate, metallic bicarbonate, or a mixture thereof, thereby reducing the amount of dissolved metallic ion from the aqueous solution.

2. The method of claim 1, wherein the solubility constant for the metallic carbonate or metallic bicarbonate is about 10⁻³ or less under standard conditions.

3. The method of claim 1, wherein the metallic ion comprises a hardness ion, sodium ion, lithium ion, or a mixture thereof.

4. The method of claim 3, wherein the hardness ion comprises an alkali earth metal ion, a transition metal ion, or a combination thereof.

5. The method of claim 3, wherein the hardness ion comprises calcium ion, magnesium ion, manganese ion, barium ion, strontium ion, or a combination thereof.

6. The method of claim 1, wherein at least about 50% of the metallic ion is removed.

7. The method of claim 1, wherein the aqueous solution comprises industrial process water, oil field produced water, frac flowback water, saline water, other brackish water, or a combination thereof.

8. The method of claim 1, wherein the carbonate ion is produced by dissolving carbon dioxide in an aqueous solution under conditions sufficient to produce carbonate ion.

9. The method of claim 1, wherein the carbonate ion is produced by dissolving trona, sodium carbonate, sodium bicarbonate, sodium sesquicarbonate, other carbonate, or a combination thereof.

10. The method of claim 8, wherein the carbon dioxide is produced from an industrial process.

11. The method of claim 8 further comprising maintaining the pH of the aqueous solution at about pH 8 or higher.

12. The method of claim 11, wherein said step of maintaining the pH of the aqueous solution comprises adding a hydroxide ion source or generating hydroxide ions.

13. The method of claim 12, wherein said step of maintaining the pH of the aqueous solution comprises generating hydroxide ions.

14. The method of claim 13, wherein hydroxide ions are generated by a process comprising electron beam, corona discharge, particle beam, ultrasonic cavitation, hydrodynamic cavitation, ultraviolet light, plasma, electrolysis, radio or microwave radiation, or a combination thereof.

15. A method for reducing the amount of dissolved hardness ion from an aqueous solution comprising the same, said method comprising producing hydroxide ion from the aqueous solution to precipitate a hydroxide of the hardness ion, thereby reducing the amount of dissolved hardness ion from the aqueous solution.

16. The method of claim 15, wherein the hydroxide ion is generated by a process comprising electron beam, corona discharge, particle beam, ultrasonic cavitation, hydrodynamic cavitation, ultraviolet light, plasma, electrolysis, radio or microwave radiation, or a combination thereof.

17. The method of claim 16, wherein the hydroxide ion is generated by a process comprising corona discharge.
